(19) United States
(12) Patent Application Publication
(10) Pub. No.: US 2006/0081116 A1
(43) Pub. Date: Apr. 20, 2006

(54) Musical instrument accessory support device

(76) Inventors: David Jay Copeland, McMurray, PA (US); Charles Robert Elder, Strabane, PA (US)

Correspondence Address: DAVID JAY COPELAND, 103 BRANDYWINE DRIVE, MCMURRAY, PA, 15317, US

(21) Appl. No.: 11/223,239

(22) Filed: Sep. 12, 2005

Related U.S. Application Data
(63) Continuation of application No. 60/618,879, filed on Oct. 14, 2004.

(51) Int. Cl. G10D 13/02

(52) U.S. Cl. 84/421

(57) ABSTRACT

The accessory support device is mechanically integrated into a musical instrument and provides a platform to which another instrument such as a cymbal, bell or woodblock, or an instrument accessory, such as a microphone, electronic triggering device, sheet music holder, wireless transmitter etc., may be mechanically applied.

### CROSS REFERENCE TO RELATED APPLICATIONS

U.S. patent application Ser. No. 11/223,239 dated Sep. 12, 2005

U.S. Patent Application No. 60/618,879 dated Oct. 14, 2004

### FIELD OF THE INVENTION

The invention relates to an integrated support structure for supporting musical instruments, microphones, accessories and the like.

### CRITICISM OF THE PRIOR ART

Percussion instruments are often grouped closely so that one performer may play several or many, and when recording or amplifying the volume of the instrument(s), a microphone is employed. Typical percussion set-ups may require many microphones. Until now, microphones were supported on floor stands, an accessory rail or devices that clip to the instrument being amplified.

Floor stands are massive (some exceed 20 lbs.) and require a large volume of scarce stage, orchestra pit or studio space (footprint). Floor stands require time to set up and position.

Floor stands may be unstable posing a hazard to performers and damage to property. Floor stands are mostly unusable in marching band applications.

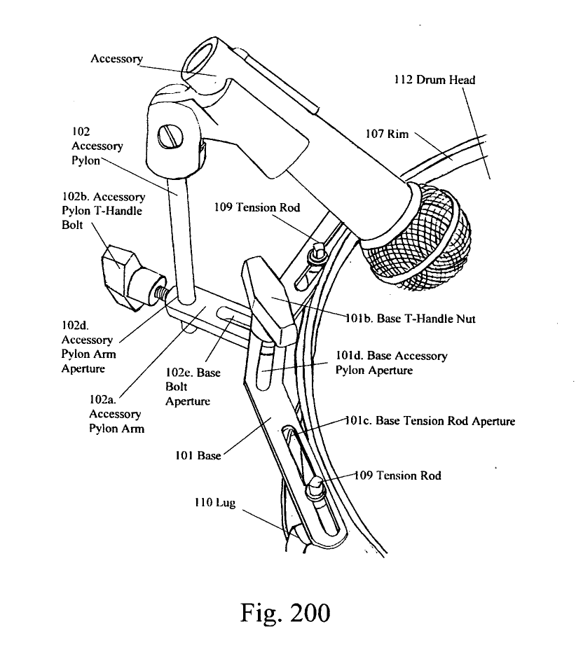

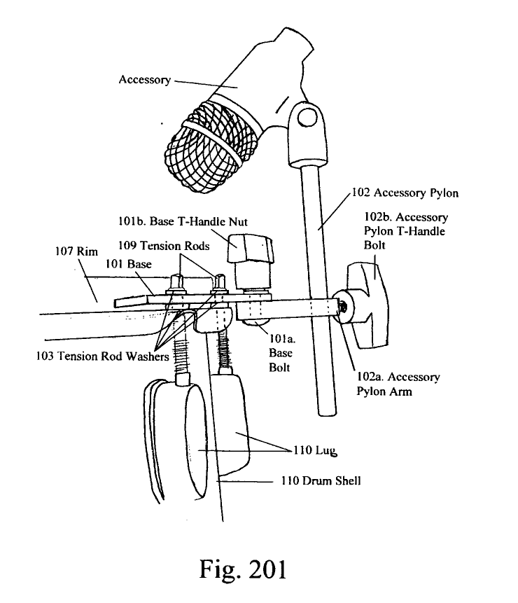

Clip devices, while compact and lightweight, are unstable as well. In some cases, the “clip” that attaches the device to the instrument is generically shaped so as to grip whatever instrument the user needs it to grip. This compromise results in mediocre results when employed on the rim of a drum, as vibration of the performance causes the microphone to “wander” from its optimal position as well as possibly falling completely away from the instrument, potentially damaging the microphone. Additionally, the clip devices available today have a narrow range of adjustability, and are not stable enough to support another instrument that will be struck with a stick or mallet, such as a cymbal or woodblock. These devices also must be removed from the instrument before stowing for transportation and reinstalled during setup for the next performance. Examples of this prior art include U.S. patents granted to Cohen (U.S. Pat. No. 4,466,596 Aug. 21, 1984), Liao (U.S. Pat. No. 5,684,258 Nov. 4, 1997). See FIGS. 300 through 305 (other prior art is also represented here). FIGS. 300-305 moved to end of document.

Accessory rails, though stable, are also massive and require considerable time to assemble and disassemble. (Porcaro U.S. Pat. No. 4,579,229 Apr. 1, 1986) and (Austin U.S. Pat. No. 5,337,646 Aug. 16, 1994). See FIGS. 306 and 307. FIGS. 306, 307 moved to end of document.

Prior art represented in Sargent (U.S. Pat. No. 6,502,793 Jan. 7, 2003) attaches to the drum secured by a hook attached to single tension rod and the support rests on the finished side of the drum shell, possibly abrading the finish when subjected to the vibrations that occur when striking the drum on which it is mounted, diminishing the appearance and value of the instrument. It must be removed before transporting the drum, and has limited adjustability for optimizing position of the accessory for which it is deployed. It is also unusable when the drum is suspended by suspension systems that support the drum by the tension rods. See FIG. 308. FIG. 308 moved to end of document.

Prior art represented by May (U.S. Pat. No. 4,570,522 Feb. 18, 1986) is expensive and complex. The microphone is placed inside the drum where the acoustic environment is entirely different than the acoustical environment outside of the drum. There is considerable effort required to replace the microphone if a change is needed, and all microphones may not be adaptable to the May mount, indeed some microphones will not fit inside smaller drums. The May system requires that the drum is damaged by drilling holes to accommodate the May system. See FIG. 309. FIG. 309 moved to end of document

### DETAILED DESCRIPTION

### PREFERRED EMBODIMENT

The base (101) describes an arc that spans the circumference of the rim (107) of the drum a sufficient distance to encompass a plurality of tension rods (109). Base tension rod apertures (101c) are provided at such intervals that the tension rods (109) pass through said apertures and through the rim (107) of the drum and then into the lugs (110). As said tension rods (109) are tightened the base (101) becomes firmly attached to the drum.

Accessories may now be attached to the base (101).

### ADDITIONAL EMBODIMENTS

The base (101) may describe a single tension rod aperture (101c).

An accessory strut, pylon, or support (102) may be attached mechanically to the base (101).

The proximal end of the accessory pylon (102) is attached to the base (101) by mechanical means.

Accessories are attached to the distal end of the accessory pylon (102) by mechanical means.

The accessory pylon (102) may articulate the accessory in three dimensions by mechanical means.

The rim (107) need not be installed on the drum.

Explanation of drawings includes more detail.

### EXPLANATION OF THE DRAWINGS

200. Assembled and Installed on a Musical Drum—the Preferred Embodiment (Perspective)
201. Assembled and Installed (Profile)
300. Prior art; Cohen, U.S. Pat. No. 4,466,596, Aug. 21, 1984
301. Prior art; Liao, U.S. Pat. No. 5,684,258, Nov. 4, 1997
302. Prior art; Wolf, U.S. Pat. No. D305026, Dec. 12, 1989
303. Prior art; Currently made by Sennheiser
304. Prior art; Currently made by Beyerdynamic
305. Prior art; Cheng, U.S. Pat. No. 6,757,400, Jun. 29, 2004
306. Prior art; Porcaro, U.S. Pat. No. 4,579,229, Apr. 1, 1986
307. Prior art; Austin, U.S. Pat. No. 5,337,646, Aug. 16, 1994
308. Prior art; Sargent, U.S. Pat. No. 6,502,793, Jan. 7, 2003
309. Prior art; May, U.S. Pat. No. 4,570,522, Feb. 18, 1986
   List of Reference Numbers, Drawings 200 and 201
101. Base
   101a. Base bolt
   101b. Base t-handle nut.
   101c. Base tension rod aperture
   101d. Base accessory pylon aperture
102. Accessory pylon
   102a. Accessory pylon arm
   102b. Accessory pylon t-handle bolt
   102d. Accessory pylon arm aperture
   102e. Base bolt aperture
103. Tension rod washers
104. Retainers
105. Washer
106. Lock washer
107. Rim
108. Rim tension rod aperture
109. Tension rod
110. Lug
111. Drum shell
112. Drum head

### ASSEMBLY AND INSTALLATION (PREFERRED EMBODIMENT)

For the purposes of this example, it is assumed that the Accessory Support Device is to be applied to a fully assembled, pitch-tunable and fully playable musical DRUM.
1. Determine the best location for the accessory in relationship to the pitch-tuning tension rods (109). Make a note of the tension rods so identified.
2. Completely remove/extract from their lugs (110) and the rim (107) only the tension rods (109) and associated washers (103) identified in step 1.
3. Position the base (101) of the Accessory Support Device in the path of the tension rods (109) removed in step 2, so that when reinstalled, the tension rods (109) may pass through the tension rod apertures (101c) in the base (101) of the Accessory Support Device and through the rim apertures and thence into each lug (110) from whence said tension rod (109) was removed.
4. During the next step (5), the base (101) should be sandwiched between two tension rod washers (103) to facilitate instrument tuning and prevent the base from contacting the drum.
5. Reinstall tension rods (109) being careful to employ tension rod washers (103) on tension rods above and below the base (101).
6. Tune the drum to the desired pitch.
7. Attach desired accessory, accessory pylon (102) or other item to the base (101).
   Stow for Transportation

The Accessory Support Device usually does not need to be removed from the drum for most stowage and/or transportation.
8. If necessary, remove the accessory or other item from the base (101).
9. Loosen both t-handles and lower the accessory pylon until just the threads on the top of the accessory pylon (102) are protruding from the arm (102a).
10. Tighten accessory pylon t-handle (102b).
11. Rotate and/or slide the arm (102a) until the accessory pylon (102) is contacting the base (101) on either side.
12. Tighten base t-handle nut (101b).
13. Stow drum.

Thus, the reader will see that the Musical Instrument Accessory Support Device provides a stable, highly reliable platform on which to attach accessories.

The above description should not be construed to as limitations on the scope of the invention, but rather as an exemplification of possible embodiments thereof.

Accordingly, the scope of the invention should be determined not by the embodiments illustrated, but by the claims and their legal equivalents.

Having thus described the invention, it is claimed:

1. A support for attaching an accessory to a musical instrument, the support comprising: a base spanning the circumference of the instrument sufficient to engage one or a plurality of tension rods providing a mechanical means of attaching an accessory to the instrument, the base having one or a plurality of apertures through which pass one or a plurality of tension rods or bolts or screws.
